(19) United States
(12) Patent Application Publication
(10) Pub. No.: US 2025/0299384 A1
(43) Pub. Date: Sep. 25, 2025

(54) EFFECT EDITING

(71) Applicants: Beijing Zitiao Network Technology Co., Ltd., Beijing (CN); Lemon Inc., Grand Cayman (KY)

(72) Inventors: Kewei Chen, Beijing (CN); Bei Li, Beijing (CN); Jie Li, Los Angeles, CA (US); Siyao Yang, Los Angeles, CA (US); Runze Zhang, Los Angeles, CA (US); Guangyao Ni, Beijing (CN)

(21) Appl. No.: 18/987,292

(22) Filed: Dec. 19, 2024

(30) Foreign Application Priority Data
Mar. 20, 2024 (CN) 202410324524.X

(51) Int. Cl. G06T 11/00

(52) U.S. Cl. CPC G06T 11/001; G06T 2200/24

(57) ABSTRACT

The embodiment of the disclosure relates to a method and an apparatus of effect editing, a device and a computer-readable storage medium. The method provided by the disclosure includes: presenting a texture generation component based on a received texture creation request; obtaining at least one generation parameter via the texture generation component, the at least one generation parameter including prompt information; creating a texture material based on the at least one generation parameter; and generating a target effect based on the texture material. In this way, the embodiments of the disclosure may add the texture material related to the generated content in the effect creation process, thereby improving the efficiency of the effect editing.

### CROSS-REFERENCE

This present application claims priority to Chinese Patent Application No. 202410324524.X, entitled “METHOD AND APPARATUS OF EFFECT EDITING, DEVICE AND STORAGE MEDIUM” filed on Mar. 20, 2024, the entirety of which is incorporated herein by reference.

### FIELD

Example embodiments of the present disclosure generally relate to the field of computers, and in

particular, to effect editing.

### BACKGROUND

With the development of computer technologies, Internet has become an important platform for creating and sharing a media content. In the creating process of the media content, a video effect and an image effect are often used by a user in the creating process. The effect can enrich the media content created by the user and make the content more interesting.

### SUMMARY

In a first aspect of the present disclosure, a method of effect editing is provided. The method includes: presenting a texture generation component based on a received texture creation request; obtaining at least one generation parameter via the texture generation component, the at least one generation parameter including prompt information; creating a texture material based on the at least one generation parameter; and generating a target effect based on the texture material.

In a second aspect of the present disclosure, an apparatus for effect editing is provided. The apparatus includes: a presentation module, configured to present a texture generation component based on a received texture creation request; an obtaining module, configured to obtain at least one generation parameter via the texture generation component, the at least one generation parameter including prompt information; a creation module, configured to create a texture material based on the at least one generation parameter; and a generating module, configured to generate a target effect based on the texture material.

In a third aspect of the present disclosure, an electronic device is provided. The device includes at least one processing unit; and at least one memory coupled to the at least one processing unit and storing instructions for execution by the at least one processing unit. The instructions, when executed by at least one processing unit, cause the device to perform the method of the first aspect.

In a fourth aspect of the present disclosure, a computer-readable storage medium is provided. The computer-readable storage medium stores a computer program which, when executed by a processor, implements the method of the first aspect.

It should be understood that the content described in this content section is not intended to limit the key features or important features of the embodiments of the present disclosure, nor is it intended to limit the scope of the present disclosure. Other features of the present disclosure will become easily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2A illustrates an example editing interface according to some embodiments of the present disclosure;

FIG. 2B illustrates a flowchart of an example execution process of an effect file according to some embodiments of the present disclosure;

FIG. 3 illustrates a flowchart of an example process of effect editing according to some embodiments of the present disclosure;

FIG. 4 illustrates a schematic structural block diagram of an example apparatus for effect editing according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the terms “including” and the like should be understood as “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, manufactured, forwarded, used, etc., all of which are performed on the premise that the user knows and confirms. Accordingly, when implementing the embodiments of the present disclosure, the types of the data or information, the usage scope, the usage scenario that may be involved, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, if personal information processing is involved, processing may be performed on the premise of having a legality basis (for example, obtaining consent of a personal information subject, or necessary for performing a fulfillment contract), and processing may be performed only within a specified or agreed range. The user rejects personal information other than necessary information required by the basic function, and does not affect the basic function of the user.

As mentioned above, in the creating process of the media content, video effects and image effects are often used by a user in the creating process. The effect can enrich the media content created by the user and make the content more interesting.

Some conventional schemes, for example, may support introducing generative artificial intelligence techniques to, for example, provide transformation effects between different images. However, a developer has a relatively limited control capability over such a change effect, which is difficult to achieve a finer effect.

The embodiment of the present disclosure provides an effect editing scheme. According to the scheme, a texture generation component can be presented based on a received texture creation request; at least one generation parameter is obtained via the texture generation component, and the at least one generation parameter includes prompt information; the texture material is created based on the at least one generation parameter; and the target effect is generated based on the texture material.

In this way, embodiments of the present disclosure may add texture material related to the content generated based on a prompt in an effect creating process, thereby improving efficiency of effect editing.

Various example implementations of this scheme are described in detail below in conjunction with the accompanying drawings.

### Example Environment

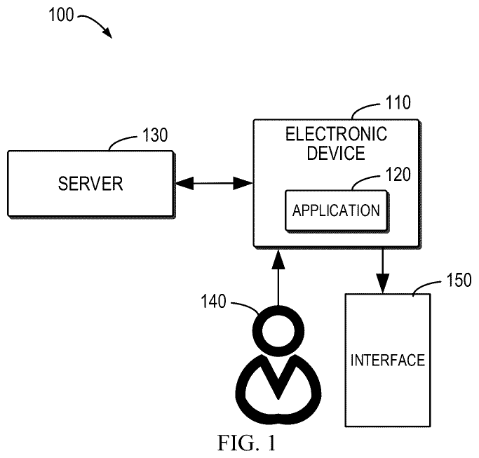

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. Application 120 may be any suitable type of application for interface interaction, examples of which may include, but are not limited to: effects editing applications. The user 140 may interact with the application 120 via the electronic device 110 and/or its attachment device.

In the 100 of FIG. 1, if application 120 is active, the electronic device 110 may present, via application 120, an interface 150 that supports interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

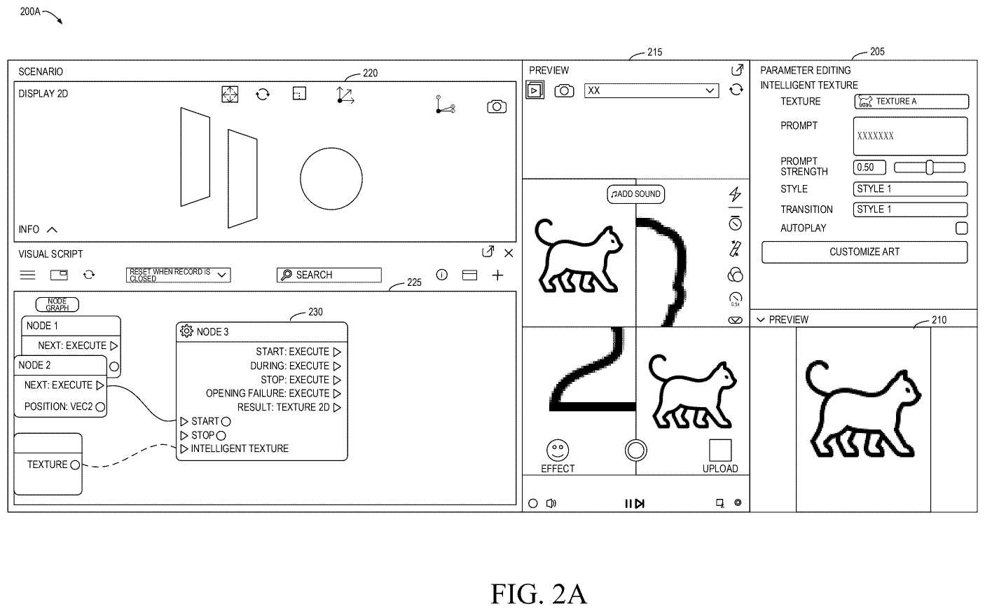

FIG. 2A illustrates an example editing interface 200A according to some embodiments of the present disclosure. The editing interface 200A may be provided, for example, by the electronic device 110 shown in FIG. 1. As an example, the interface 200A may be an editing interface for editing an effect.

In some embodiments, the electronic device 110 may receive a texture creation request initiated by a user in the editing interface 200A. Accordingly, the electronic device 110 may provide the texture generation component 205 in the editing interface 200A.

In some embodiments, such a texture generation component 205 may provide one or more controls for obtaining at least one production parameter associated with the texture material.

In some embodiments, such a texture generation component 205 may include a prompt input control for obtaining prompt information input by a user, for example, prompt. As an example, such prompt information may include a description of expected media content (e.g., an image).

In some embodiments, the texture generation component 205 may further include a style selection control. As an example, the style selection control may provide a set of candidate styles, and the electronic device 110 may receive a target style selected by the user from the set of candidate styles as a generation parameter.

In some embodiments, such a set of candidate styles may include a predetermined set of styles. Alternatively, in order to improve the stability of content generation, the electronic device 110 may also receive service information from a management device associated with the generation service, and such service information may, for example, indicate one or more allowed styles by the current generation service. As an example, such a management device may be used to provide content generation services that may be used by electronic device 110. For example, such a management device may include a server 130.

Accordingly, the electronic device 110 may provide one or more allowed styles indicated by the service information in the style selection control as the set of candidate styles based on the received service information.

In this way, the embodiments of the present disclosure may ensure consistency with the generation service and avoid errors in the service invocation process.

In some embodiments, the texture generation component 205 may further include a dynamic effect selection control. As an example, the dynamic effect selection control may provide a set of candidate dynamic effects (also referred to as motion effects), and the electronic device 110 may receive a target dynamic effect selected by the user from a set of candidate dynamic effects as the generation parameter.

As an example, such a dynamic effect may, for example, indicate a transitional action between the input media content (e.g., an image) to another media content generated based on the prompt information.

Taking FIG. 2A as an example, the electronic device 110 may, for example, provide an input control for obtaining the first media content (e.g., texture A). Further, the electronic device 110 may further provide a preview of the second media content 210 generated based on the generation parameters (e.g., prompt information, style, etc.) in the texture generation component.

In some embodiments, the texture generation component 205 may further include a play control for configuring whether the target dynamic effect is automatically played. For example, in response that the play control is selected, the texture may automatically implement a dynamic transition effect from the first media content to the second media content.

In some embodiments, the texture generation component 205 may also provide a preview entry (e.g., a “customize art” button). Upon receiving the selection of the preview entry, the electronic device 110 may provide a preview interface. The preview interface may be used to debug one or more parameters related to generating the second media content.

For example, the preview interface may provide one or more controls associated with the content generation service. The electronic device 110 may obtain, via the one or more controls, a generation parameter to be debugged by the user, for example, a prompt, a model strength, style information, and the like. Further, the electronic device 110 may further receive uploaded media content (for example, an image) via the preview interface, may invoke the generation service, and may provide a preview of the generated media content (for example, an image generated by using the generation service) according to the generation parameter obtained in the preview interface and the received media content. In this way, the user may modify the generation parameters through the preview interface to obtain the expected generation effect.

Further, the electronic device 110 may create the texture material based on the obtained at least one generation parameter. Further, such texture material may be applied to a process of effect editing.

In some embodiments, the electronic device 110 may, for example, add a first object corresponding to the created texture material based on an editing operation of the user, so that the effect may present a dynamic effect process corresponding to the texture material at a corresponding position in the image.

As an example, the electronic device 110 may add an object corresponding to the texture material based on an editing operation of the user. As an example, the object may be a sticker loaded in the image. For example, in response to a corresponding trigger at the corresponding position in the image, the electronic device 110 may display such texture material, according to a sticker presentation logic configured for the effect.

In some embodiments, the electronic device 110 may further configure an input texture of the texture material. For example, the electronic device 110 may use a node graph as discussed below to set a particular region or particular element in the image to be an input texture of a texture material.

As an example, the electronic device 110 may, for example, indicate, based on an editing operation of the user, a region of the image with a specific semantic meaning as the input texture of the texture material. Correspondingly, during the running stage of the effect, the effect file may obtain an image captured by the camera, and may, for example, detect a target region (for example, a desktop region) with a specific semantic meaning as the input texture of the texture material. In addition, the effect file may generate content based on the generated parameter and a picture of the target region. Correspondingly, the electronic device 110 may display the transition effect from the initial picture of the target region to the generation result.

Therefore, by editing the dynamic effect related to the generated content in the form of the texture material, the embodiments of the present disclosure may support applying finer dynamic effect on elements of the picture element, thereby enriching the created effect.

Additionally, in order to facilitate the user to preview the effect of the texture material, in response that the first media content corresponding to the texture material is specified, the electronic device 110 may display a process in the preview region 215 that the first media content transitions to the second media content generated based on the generation parameters according to the selected dynamic effect.

In some embodiments, similar to the other texture materials, the electronic device 110 may further associate the created texture material with the second object in the effect to be edited. Taking the scene preview region 220 as an example, the electronic device 110 may, for example, receive a selection of a specific object in the preview region 220, and configure its texture information as the created texture material.

In some embodiments, such a second object may include, for example, any suitable object to be loaded in a picture with an effect. As an example, the effect, for example, indicates that one or more cubes are added on a picture captured by the camera. Accordingly, the electronic device 110 may associate the created texture material to such a cube based on a user's editing operation.

Thus, during the execution process of the effect file, such a cube may generate a corresponding image according to the generation parameter related to the texture material, and may display such an image on the surface of the cube. Further, the surface of such a cube may also present, according to the configured dynamic effect parameters, a transition effect from the initial picture of the cube to the generated final texture.

Based on such a manner, embodiments of the present disclosure may also support applying the created texture material to a specific object in the effect, thereby supporting the surface region associated with the specific object to show the generated media content.

In this manner, in the preview window 215, the electronic device 110 may present a process of transitioning from displaying the first media content to displaying the second media content on the surface of the second object.

Based on this manner, the embodiments of the present disclosure may support the user to apply the dynamic effect related to the generated content on the appropriate object with the effect, thereby improving the flexibility of the effect editing.

In some embodiments, the electronic device 110 may also support editing an effect through the effect node graph 225. Specifically, the electronic device 110 may add the node 230 corresponding to the generated texture material in the node graph 225, and may generate a final effect based on the edition of the node 230.

Specifically, the electronic device 110 may modify the attribute information of the node 230 by connecting another node to it. For example, the electronic device 110 may connect another node to the “start” port of the node 230 to indicate a start condition of the node 230, that is, a condition that a dynamic effect corresponding to the texture material is triggered to be executed.

Additionally, the electronic device 110 may also support the user editing an end condition of node 230, that is, a condition for stopping presentation of the dynamic effect. In addition, the electronic device 110 may further support the user editing an input texture of node 230, for example, may support the user to upload a picture or take a picture as an input texture of the texture material.

Additionally, the electronic device 110 may also support the user editing an action of node 230 triggered due to a satisfaction of at least one condition. Such an action may include, for example, an action triggered after the node 230 is started, an action triggered during the execution of the node 230, an action triggered when the node 230 is stopped, an action triggered when the node 230 fails to open, and the like.

In this way, embodiments of the present disclosure may support a user to more finely manage texture materials related to the generated content, thereby improving efficiency of effect editing, and supporting creation of richer effects.

In some embodiments, the electronic device 110 may also post a corresponding effect file based on the post request of the user. FIG. 2B further illustrates an execution process of an effect file according to some embodiments of the present disclosure.

As shown in FIG. 2B, at step 250, the effect file starts to be executed; at step 252, the effect file obtains the next frame of image; at step 254, the effect file determines whether the intelligent generation request is running; if yes, it may proceed to step 252, and continue to obtain the next frame of image.

If no intelligent generation request is running, the effect file may initialize the setup environment at step 256 and initialize the result texture at step 258. Further, the effect file may set up parameters at step 260 and send an algorithm request to invoke a corresponding generation service.

At step 262, the effect file may set the algorithm to be occupied. Further, at step 264, the effect file may determine whether the invoking process is paused. Without pausing, the effect file may obtain the search results at step 266. If the search result is not obtained, the effect file may return to step 252 and obtain the next frame of image.

In contrast, if the search result is successfully obtained, the effect file may blend the image frame and the search result at step 268 and transition the dynamic effect according to the specified dynamic effect parameter. After the dynamic effect presentation is completed, the effect file may perform a completion of callback at step 270 until processing is completed at step 276.

Conversely, if the search result fails to be obtained at step 266, the effect file may display error information at step 272 and perform an error callback at step 274 until processing is completed at step 276.

Therefore, the effect file may invoke a generation service according to the at least one generation parameter obtained in the editing process to obtain a generated image, thereby providing a corresponding target effect.

Based on the above process, embodiments of the present disclosure may enrich dynamic effect related to the generated content in effect creation, thereby improving the efficiency of effect creation.

### Example Processes

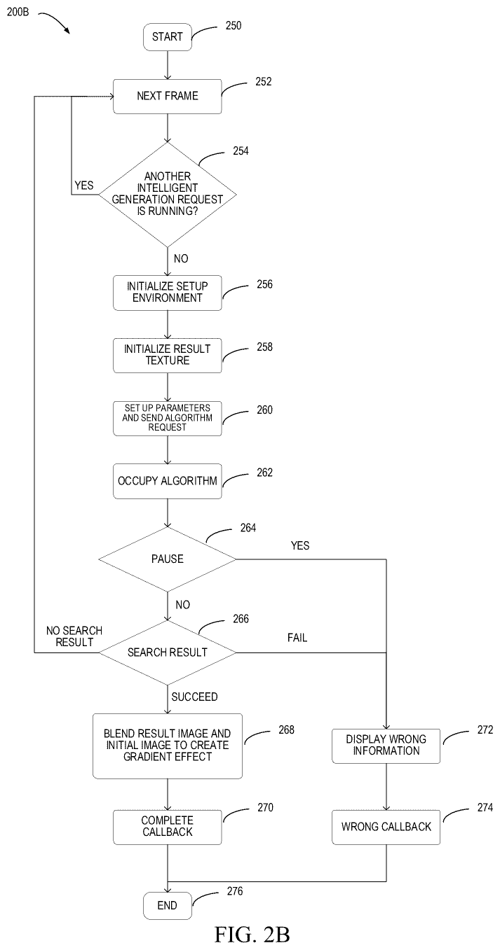

FIG. 3 illustrates a flowchart of an example process 300 of editing an effect according to some embodiments of the present disclosure. Process 300 may be implemented at electronic device 110. Process 300 is described below with reference to FIG. 1.

As shown, at block 310, electronic device 110 presents a texture generation component based on a received texture creation request.

At block 320, electronic device 110 obtains at least one generation parameter via the texture generation component, where at least one generation parameter includes prompt information.

At block 330, the electronic device 110 creates a texture material based on at least one generation parameter.

At block 340, the electronic device 110 generates a target effect based on the texture material.

In some embodiments, the texture generation component includes a style selection control configured to provide a set of candidate styles, the at least one generation parameter further including a target style selected from the set of candidate styles.

In some embodiments, process 300 further includes: receiving service information from a management device indicating the allowed set of candidate styles; and providing the set of candidate styles in the texture generation component based on the service information.

In some embodiments, the texture generation component includes a dynamic effect selection control configured to provide a set of candidate dynamic effects, the at least one generation parameter further including a target dynamic effect selected from the set of candidate dynamic effects.

In some embodiments, the texture material includes a transition between a first media content and a second media content according to the target dynamic effect, and the second media content is generated based on the first media content and the prompt information.

In some embodiments, the texture material further includes an input control for obtaining the first media content.

In some embodiments, the texture generation component includes a play control for configuring whether the target dynamic effect is automatically played.

In some embodiments, the process 300 further includes presenting a preview interface based on a selection of a preview entry in the texture generation component, where the preview interface is configured to: obtain a third media content and a set of generation parameters; and provide a fourth media content generated based on the set of generation parameters and the third media content.

In some embodiments, the process 300 further includes: adding a first object corresponding to the texture material; or applying the texture material to a second object in an effect to be edited.

In some embodiments, generating a target effect based on the texture material includes adding a target node corresponding to the texture material in a node graph of the target effect; and generating the target effect based on an edition of the target node.

In some embodiments, the edition of the target node includes editing attribute information of the target node, and the attribute information includes at least one of the following: a start condition of the target node; an end condition of the target node; an input texture of the target node; an action of the target node triggered due to a satisfaction of at least one condition.

In some embodiments, the process 300 further includes: posting an effect file corresponding to the target effect, where the effect file is configured to invoke a service according to the at least one generation parameter to obtain a generated image, thereby providing a corresponding target effect.

### Example Apparatus and Device

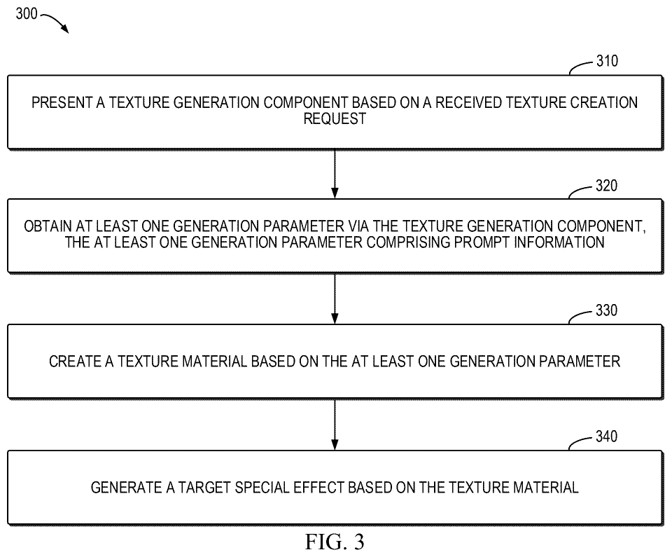

Embodiments of the present disclosure also provide a corresponding apparatus for implementing the above method or process. FIG. 4 illustrates a schematic structural block diagram of an example apparatus 400 for editing an effect according to some embodiments of the present disclosure. The apparatus 400 may be implemented or included in electronic device 110. The various modules/components in the apparatus 400 may be implemented by hardware, software, firmware, or any combination thereof.

As shown in FIG. 4, the apparatus 400 includes a presentation module 410 configured to present a texture generation component based on a received texture creation request; an obtaining module 420 configured to obtain at least one generation parameter via the texture generation component, the at least one generation parameter including prompt information; a creation module 430 configured to create a texture material based on the at least one generation parameter; and a generating module 440 configured to generate a target effect based on the texture material.

In some embodiments, the texture generation component includes a style selection control configured to provide a set of candidate styles, the at least one generation parameter further including a target style selected from the set of candidate styles.

In some embodiments, the apparatus 400 further includes a providing module configured to: receive service information from a management device indicating the allowed set of candidate styles; and provide the set of candidate styles in the texture generation component based on the service information.

In some embodiments, the texture generation component includes a dynamic effect selection control configured to provide a set of candidate dynamic effects, the at least one generation parameter further including a target dynamic effect selected from the set of candidate dynamic effects.

In some embodiments, the texture material includes a transition between a first media content and a second media content according to the target dynamic effect, and the second media content is generated based on the first media content and the prompt information.

In some embodiments, the texture generation material further includes an input control for obtaining the first media content.

In some embodiments, the texture generation component includes a play control for configuring whether the target dynamic effect is automatically played.

In some embodiments, the apparatus 400 further includes a preview module configured to present a preview interface based on a selection of a preview entry in the texture generation component, where the preview interface is configured to: obtain a third media content and a set of generation parameters; and provide a fourth media content generated based on the set of generation parameters and the third media content.

In some embodiments, the apparatus 400 further includes an editing module configured to: add a first object corresponding to the texture material; or apply the texture material to a second object in an effect to be edited.

In some embodiments, the generating module 440 is further configured to: add a target node corresponding to the texture material in a node graph of the target effect; and generate the target effect based on an edition of the target node.

In some embodiments, the edition of the target node includes editing attribute information of the target node, and the attribute information includes at least one of the following: a start condition of the target node; an end condition of the target node; an input texture of the target node; an action of the target node triggered due to a satisfaction of at least one condition.

In some embodiments, the apparatus 400 further includes a posting module configured to post an effect file corresponding to the target effect, where the effect file is configured to invoke a service according to the at least one generation parameter to obtain a generated image, thereby providing a corresponding target effect.

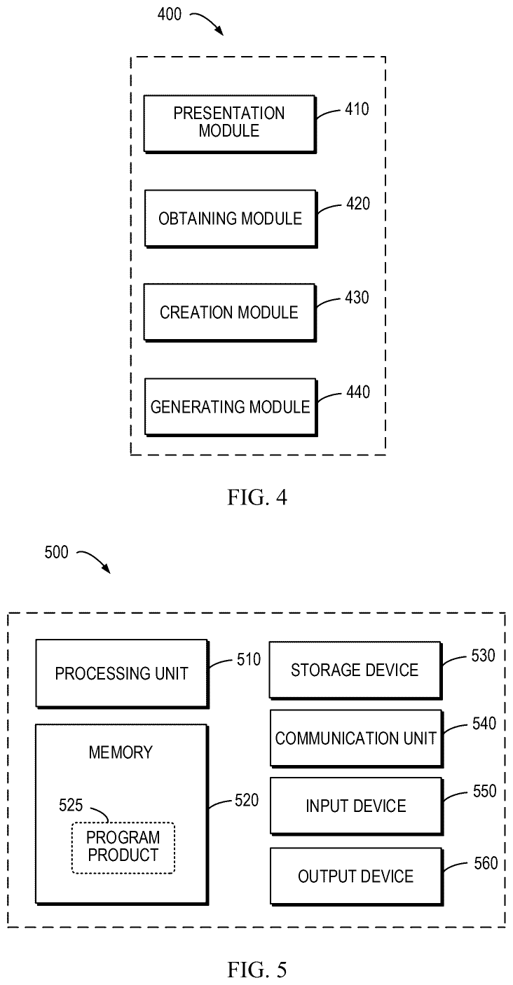

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, a computer-readable storage medium is provided. The computer-readable storage medium has computer-executable instructions stored thereon, where the computer-executable instructions, when executed by a processor, implement the method described above. According to example implementations of the present disclosure, a computer program product is further provided, the computer program product being tangibly stored on a non-transitory computer-readable medium and including computer-executable instructions. The computer-executable instructions, when executed by a processor, implement the method described above.

Aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams, may be implemented by computer readable program instructions.

These computer-readable program instructions may be provided to a processing unit of a general-purpose computer, special purpose computer, or other programmable data processing apparatus to produce a machine, such that the instructions, when executed by a processing unit of a computer or other programmable data processing apparatus, produce means to implement the functions/actions specified in the flowcharts and/or block diagrams. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/actions specified in the flowcharts and/or block diagrams.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/actions specified in the flowcharts and/or block diagrams.

The flowcharts and block diagrams in the figures show architecture, functionality, and operation of possible implementations of systems, methods, and computer program products according to various implementations of the present disclosure. In this regard, each block in the flowcharts or block diagrams may represent a module, program segment, or a portion of instructions that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method of effect editing, comprising:
presenting a texture generation component based on a received texture creation request;
obtaining at least one generation parameter via the texture generation component, the at least one generation parameter comprising prompt information;
creating a texture material based on the at least one generation parameter; and
generating a target effect based on the texture material.

2. The method of claim 1, wherein the texture generation component comprises a style selection control configured to provide a set of candidate styles, the at least one generation parameter further comprising a target style selected from the set of candidate styles.

3. The method of claim 2, further comprising:
receiving service information from a management device indicating the allowed set of candidate styles; and
providing the set of candidate styles in the texture generation component based on the service information.

4. The method of claim 1, wherein the texture generation component comprises a dynamic effect selection control configured to provide a set of candidate dynamic effects, the at least one generation parameter further comprising a target dynamic effect selected from the set of candidate dynamic effects.

5. The method of claim 4, wherein the texture material comprises a transition between a first media content and a second media content according to the target dynamic effect, and the second media content is generated based on the first media content and the prompt information.

6. The method of claim 5, wherein the texture material further comprises an input control for obtaining the first media content.

7. The method of claim 4, wherein the texture generation component comprises a play control for configuring whether the target dynamic effect is automatically played.

8. The method of claim 1, further comprising:
presenting a preview interface based on a selection of a preview entry in the texture generation component, wherein the preview interface is configured to: obtain a third media content and a set of generation parameters; and provide a fourth media content generated based on the set of generation parameters and the third media content.

9. The method of claim 1, further comprising:
adding a first object corresponding to the texture material; or
applying the texture material to a second object in an effect to be edited.

10. The method of claim 1, wherein generating a target effect based on the texture material comprises:
adding a target node corresponding to the texture material in a node graph of the target effect; and
generating the target effect based on an edition of the target node.

11. The method of claim 10, wherein the edition of the target node comprises editing attribute information of the target node, and the attribute information comprises at least one of the following:
a start condition of the target node;
an end condition of the target node;
an input texture of the target node;
an action of the target node triggered due to a satisfaction of at least one condition.

12. The method of claim 1, further comprising:
posting an effect file corresponding to the target effect, wherein the effect file is configured to invoke a service according to the at least one generation parameter to obtain a generated image, thereby providing a corresponding target effect.

13. An electronic device, comprising:
at least one processing unit; and
at least one memory coupled to the at least one processing unit and storing instructions for execution by the at least one processing unit, the instructions, when executed by the at least one processing unit, cause the electronic device to perform acts comprising:
presenting a texture generation component based on a received texture creation request;
obtaining at least one generation parameter via the texture generation component, the at least one generation parameter comprising prompt information;
creating a texture material based on the at least one generation parameter; and
generating a target effect based on the texture material.

14. The electronic device of claim 13, wherein the texture generation component comprises a style selection control configured to provide a set of candidate styles, the at least one generation parameter further comprising a target style selected from the set of candidate styles.

15. The electronic device of claim 14, wherein the acts further comprise:
receiving service information from a management device indicating the allowed set of candidate styles; and
providing the set of candidate styles in the texture generation component based on the service information.

16. The electronic device of claim 13, wherein the texture generation component comprises a dynamic effect selection control configured to provide a set of candidate dynamic effects, the at least one generation parameter further comprising a target dynamic effect selected from the set of candidate dynamic effects.

17. The electronic device of claim 16, wherein the texture material comprises a transition between a first media content and a second media content according to the target dynamic effect, and the second media content is generated based on the first media content and the prompt information.

18. The electronic device of claim 17, wherein the texture material further comprises an input control for obtaining the first media content.

19. The electronic device of claim 16, wherein the texture generation component comprises a play control for configuring whether the target dynamic effect is automatically played.

20. A non-transitory computer-readable storage medium having a computer program stored thereon, the computer program, when executed by a processor, implements acts comprising:
presenting a texture generation component based on a received texture creation request;
obtaining at least one generation parameter via the texture generation component, the at least one generation parameter comprising prompt information;
creating a texture material based on the at least one generation parameter; and
generating a target effect based on the texture material.
